(19) United States
(12) Patent Application Publication
(10) Pub. No.: US 2006/0259205 A1
(43) Pub. Date: Nov. 16, 2006

(54) Controlling systems through user tapping

(75) Inventor: David Michael Krum, Palo Alto, CA (US)

Correspondence Address: COURTNEY STANIFORD & GREGORY LLP, P.O. BOX 9686, SAN JOSE, CA, 95157, US

(73) Assignee: Robert Bosch GmbH

(21) Appl. No.: 11/128,991

(22) Filed: May 13, 2005

(51) Int. Cl. G06F 17/00

(52) U.S. Cl. 701/1

(57) ABSTRACT

User interface systems and methods are described below that allow vehicle operators to control systems, devices, and/or functions of a vehicle by tapping on surfaces of vehicle components. The “tap-controlled vehicle interfaces (“TCVI”)” use sensors like accelerometers to sense arid recognize parameters of operator tapping. The parameters may include the location, strength, repetition, and rhythm of the tapping for example. The TCVI translates the parameters to specific commands that are then used to control corresponding vehicle systems of the host vehicle.

### TECHNICAL FIELD

The disclosure herein relates generally to user interfaces and, more particularly, to interfaces for controlling devices via striking of interactive surfaces.

### BACKGROUND

Drivers must contend with many demands for their attention. While not recommended, it is not uncommon to encounter a driver using a portable electronic device like a cellular telephone, reaching to control or adjust a vehicle entertainment system, and/or reaching to control a vehicle climate control system. These interactions can lead to distracted drivers and consequently to accidents or other vehicle mishaps. Therefore, it is important that controls for vehicle systems like entertainment and/or climate control systems have a minimal impact on the driver's ability to operate the vehicle.

One approach for improved vehicle interaction employed controls (e.g., buttons) that were integrated into vehicle components like the steering wheel, shift control device, and turn signal control. While interaction with earlier conventional controls such as those on/in the dashboard was more likely to divert the driver's eyes away from the road, integrated controls allowed control of vehicle systems without requiring the driver to remove his/her hands from the vicinity of the steering wheel.

Typical placement of the buttons integrated into the steering wheel for example meant drivers were not required to remove their hands from the vicinity of the steering wheel in order to activate the buttons. However, the drivers often needed to slide their hands along the wheel, away from a recommended driving position (e.g., the ten/two o'clock positions or nine/three o'clock positions). Thus this solution has not proved ideal because deviation from these recommended driving positions can lead to diminished vehicle control.

Furthermore, there were limits on the number and location of buttons that could be placed on the steering wheel. A large number of buttons created clutter and made it difficult for a driver to find a particular button by touch alone. Also, the buttons could only be placed in a limited area where they did not interfere with steering; thus buttons could not be placed on the steering wheel grips, for example, as they interfered with the driver's control of the vehicle.

Additionally, there were significant engineering and manufacturing cost involved in placing controls on the steering wheel. For example, each new control function requires a new button and new wiring that must be routed from a moving steering wheel into a stationary steering column, and must be designed to handle the stress and wear of that rotational joint. The buttons must also be designed so as not to interfere with the operation of the air bag passive restraint system.

### BRIEF DESCRIPTION OF THE DRAWINGS

FIG. 1 is a block diagram of a tap-controlled vehicle interface (“TCVI”), under an embodiment.

FIG. 2 is a flow diagram for automatically controlling devices by sensing tapping of a user, under an embodiment.

FIG. 3 is a block diagram of a TCVI in an automobile, under an embodiment.

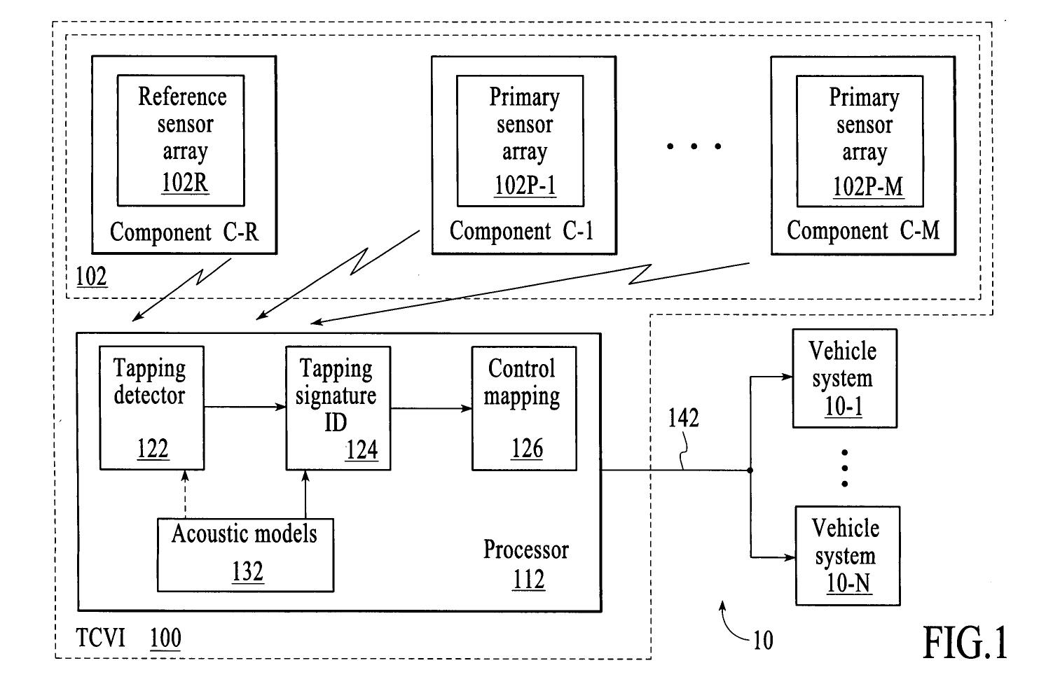

In the drawings, the same reference numbers identify identical or substantially similar elements or acts. To easily identify the discussion of any particular element or act, the most significant digit or digits in a reference number refer to the Figure number in which that element is first introduced (e.g., element 100 is first introduced and discussed with respect to FIG. 1).

### DETAILED DESCRIPTION

User interface systems and methods are described below that allow vehicle operators to control systems, devices, and/or functions of a vehicle by tapping on surfaces of vehicle components. The user interface systems and methods, collectively referred to herein as “tap-controlled vehicle interfaces (“TCVI”)”, generally use sensors to sense and recognize parameters of the operator's tapping. The parameters may include the location, strength, repetition, and rhythm of the tapping but are not so limited. The TCVI translates the parameters to specific commands that are then used to control corresponding vehicle systems (also referred to as “vehicle devices”, “vehicle functions”, and/or “vehicle components”) in the host vehicle. For example, the operator can tap an area of the steering wheel twice and the TCVI detects and recognizes these taps as a request to generate and transfer an “increase volume” signal to the vehicle entertainment system.

The term “tap” or “tapping” is used herein to include tap, strike, knock, rap, pat, thump, and action terms of similar import. Tapping generally includes contact between someone's hand and a surface of another object, where the contact may include contacting the surface more than one time. For example, the tapping may include time-varying contact with a surface expressed as a unique pattern or rhythm of movement over an interval of time. The pattern or rhythm may include tapping the surface a varying number of times, in different locations, with varying intensity, and in particular rhythms but is not so limited. Further, a variety of commands can be defined in response to tapping using any number of different and repeatable patterns of tapping expressed over an interval of time and mapped to one or more systems and/or system functions (e.g., changing the volume of an entertainment system, changing the temperature of a climate control system, etc.) of the host vehicle.

The TCVI may replace and/or supplement the use of buttons or other switches that are integrated into a vehicle. As one example, the TCVI may replace buttons integrated into an automobile steering wheel with tap control of the vehicle systems that correspond to the buttons. The TCVI generally includes some number of accelerometers coupled to a signal processor, or signal processing computer. The TCVI also includes use of vibration and acoustic models as appropriate to a configuration of the accelerometers as well as the environment of the host vehicle, and couplings or control channels to the vehicle systems operating under control of the TCVI. The TCVI thus allows the vehicle operator to control vehicle systems by tapping some pre-specified surface in the vehicle a varying number of times, in different locations, with varying intensity, and in particular rhythms. The TCVI detects and interprets these different tapping parameters and in response uses a control mapping to determine a vehicle system and a parameter of the system for control. The TCVI provides a control signal to the vehicle system/parameter identified for control, for example, signaling an automobile entertainment system to increase the system volume.

The TCVI may be integrated with host vehicle systems without the need for additional buttons and wire routing for each additional control function, thereby reducing clutter in the vehicle and allowing the TCVI to be used along with conventional buttons and switches. The TCVI provides a customizable interface that allows for addition of new systems and/or functions to the host vehicle by programming the TCVI to recognize and respond to additional types and styles of tapping. Customizable parameters of the tapping (e.g., location, strength, duration, and frequency) therefore replace the need for additional buttons and wiring to control new systems/functions. Use of the TCVI also simplifies host vehicle system operation and thus improves safety of vehicle operation because the TCVI does not require visual or tactile changes to components of the host vehicle and interaction with the TCVI does not require drivers to move their hands from a standard driving position (only a single finger or thumb need be involved in tapping, leaving the driver's hold on the steering wheel intact).

While the automobile is one example of a host vehicle in which the TCVI may be used, the TCVI may be used in many other types of vehicles, systems, and/or equipment. Examples of other vehicles that may include the TCVI for use in controlling vehicle systems include, but are not limited to, cars, trucks, motorcycles, boats, recreational vehicles, buses, and operator-controlled equipment or machinery. Numerous types of surfaces in a host vehicle may be configured to detect user tapping via coupled or connected TCVI sensors. The surfaces for example may include but are not limited to surfaces of vehicle control devices like steering devices, shift control devices, foot control devices, and consoles to name a few.

In the following description, numerous specific details are introduced to provide a thorough understanding of, and enabling description for, embodiments of the TCVI. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

FIG. 1 is a block diagram of a tap-controlled vehicle interface (“TCVI”) 100, under an embodiment. The TCVI 100 includes a sensor system 102 coupled to a signal processor 112. The sensor system 102 of an embodiment, also referred to herein as a “sensor array”, includes one or more primary sensor arrays 102P-1 to 102P-M coupled or connected to surfaces of one or more respective vehicle components C-1 to C-M (where “M” is any number 0, 1, . . . X). Additionally, the sensor system 102 includes at least one reference sensor or reference sensor array 102R. The reference sensor 102R may be coupled or connected to the surface of a vehicle component C-R different from any components C-1 to C-M to which the primary sensor arrays are connected, but the embodiment is not so limited.

The TCVI of one example includes a primary sensor array 102P-1 connected to the steering wheel C-1 of a host automobile 10 along with a reference sensor array 102R connected to some other component surface C-R of the automobile like the steering column or dash assembly for example. Sensors of the primary sensor array 102P-1 may be rigidly connected to one or more areas of the steering wheel C-1, perhaps by embedding them in the material of the steering wheel or inside the grip; Sensors of the reference sensor array 102R similarly may be rigidly connected to the steering column C-R or other components of the automobile.

As another example, the TCVI may include a first primary sensor array 102P-1 connected to the steering wheel C-1 and a second primary sensor array 102P-2 connected to a gear control/shifting device C-2. In this example the reference sensor array 102R may be connected to the steering column and/or dash assembly C-R of the automobile 10, but the embodiment is not so limited.

The sensors of an embodiment include one or more accelerometers, but the embodiment is not so limited, as any number of accelerometers can be used alone or in combination with any number and/or type of other sensor. The sensors may use accelerometers under any variety of technologies, including piezoelectric, piezoresistive, and capacitive accelerometers to name a few. Accelerometers are sensors that react to accelerations associated with vibration, gravity, and movement. The sensors therefore generate signals proportional to the strength and direction of the acceleration. Relative placement or configuration of both the primary and reference sensors allows the TCVI to distinguish between global accelerations (those affecting the entire vehicle) and local accelerations of the operator's tapping (those affecting the steering wheel only). Consequently, sensor configuration/placement is as appropriate to the size, shape, material composition, and areas of sensitivity of any component to which sensors are affixed as well as the environment of the host vehicle.

The sensor system 102 may be coupled to the signal processor 112, also referred to as a signal processing system 112 or processor 112, using any number/type of communication system components and/or protocols. For example, the communication system (collective reference to communication system components and/or protocols) may include at least one of transmitters, receivers, and transceivers as appropriate to communication protocols used by the sensor system 102 and the signal processor 112. The communication system transfers information between the sensor system 102, signal processor 112, and/or other components of the host vehicle system 10 using at least one of wireless, wired, or hybrid wireless/wired communications. The communication system may additionally or alternatively include one or more of wired and wireless networks and corresponding network components, where the networks can be any of a number of network types known in the art including, but not limited to, local area networks (LANs), metropolitan area networks (MANs), wide area networks (WANs), and proprietary networks to name a few.

The sensor information is transferred to the signal processor 112 using sensor signals. Upon receipt of the sensor signals, the signal processor 112 generally performs calculations that distinguish between signals caused by operator tapping on an interactive surface and noise and/or other extraneous signals. The noise and other extraneous signals include inadvertent vibrations caused by the operator or other occupants of the vehicle, vehicle vibration, and vehicle acceleration to name a few.

The signal processor 112 also identifies or determines numerous parameters of the tapping including the location, intensity, rhythm, and repetition of the tapping. This determination is made using at least one model of the acoustic and vibration properties of the component to which the sensors are connected as well as the environment of the host vehicle. The model characterizes and describes the different ways an operator can tap a component connected to a sensor array (e.g., intensity, rhythm, pattern, etc.) and the corresponding signals produced by the sensor array. The signal processor 112 therefore analyzes the signals from the sensor array and identifies a tapping signature (also referred to as an “acoustic signature”) that corresponds to the detected tapping. Parameters of the resultant signature include the strength, arrival time, and wave envelopes of the readings at the different sensors, but are not so limited. The signal processor 112 uses information of the identified acoustic signature to control a system of the host vehicle that corresponds to the signature.

The signal processor 112 includes a tapping detector 122, tapping signature (or pattern) identification (“ID”) 124, and control mapping 126 “components”, but is not so limited. The signal processor 112 further includes acoustic models 132, which may be stored in a database (not shown) included in the processor 112 or coupled to one or more components of the processor 112. While the term “components” is generally used herein, it is understood that “components” include circuitry, components, modules, and/or any combination of circuitry, components, and/or modules as the terms are known in the art. While the components are shown as co-located, the embodiment is not to be so limited; the TCVI of various alternative embodiments may distribute one or more functions provided by the components 122-132 among any number and/or type of components, modules, and/or circuitry of the host vehicle electronics.

The signal processor 112 uses the components 122-132 to process information from the sensors arrays in order to detect and identify operator tapping intended to control a vehicle system, and to execute the desired control. For example, the tapping detector 122 detects tapping by a user on a component surface of the vehicle that includes or is connected to a primary sensor array. The tapping detector operation includes filtering or comparing of signals received from the primary sensor array and a reference sensor array in order to distinguish between tapping signals and noise and/or other extraneous signals. The output of the tapping detector 122 includes a tapping signature, which is an acoustic signature corresponding to the parameters of the detected tapping. As such, the tapping signature includes intensity, frequency, pattern, rhythm, and/or other signal information representing tapping parameters that indicate a desire by a user to initiate control of a vehicle system. The tapping detector 122 may be coupled to the acoustic models 132 in order to use information of the acoustic models in detecting operator tapping and providing a tapping signature.

The tapping signature ID component 124, which is coupled to the acoustic models 132, receives the tapping signature from an output of the tapping detector 122. The tapping signature ID component 124 identifies at least one of a location, intensity, frequency, pattern, and rhythm of the detected tapping by comparing the tapping signature with information of the acoustic models 132. The output of the tapping signature ID component 124 is an identified tapping signature. The acoustic models 132 may include any number and/or type of acoustic and vibration models as appropriate to the host vehicle and operator, and the sensor arrays, and the acoustic models 132 may be updateable. The acoustic models 132 may be stored in a catalog or other group format but are not so limited.

The control mapping component 126 maps the identified tapping signature to a system or device of the host vehicle that correspond to the tapping signature. As such, the control mapping component 126 may include mapping information corresponding to any system, device, and/or component of the host vehicle. For example, when the host vehicle is an automobile, the control mapping component 126 can include mapping information corresponding to any function of the entertainment system (e.g., media input source, output type, output destination, volume, bass, treble, fade, etc.), climate control system (e.g., function, temperature, fan speed, window select, window up control, window down control, window stop control, etc.), and communication system (e.g., on-board radio and/or telephone system, computer system, etc.), to name a few.

The control mapping component 126 also generates control signals that correspond to the device selected through the operator's tapping commands. The control mapping component automatically controls the selected device using the control signals via couplings or connections appropriate to the selected device. The signal processor 112 uses the control signals to control numerous vehicle systems by coupling the control signals to the vehicle systems via one or more control channels 142. The control channels 142 couple the signal processor 112 to any number of systems 10-1 to 10-N of a host vehicle 10 (referred to herein as “host vehicle systems”) as appropriate to a vehicle type and to the control desired from the TCVI 100 (where “N” is any number 0, 1, . . . Y).

The tapping detector 122, tapping signature ID component 124, and control mapping component may include signal analysis components that perform analysis based on any type and/or combination of signal parameters (e.g., intensity, frequency, amplitude, timing, alignment, rate, etc.), where the analysis may include any number and/or combination of conventional signal processing/analysis techniques. The TCVI 100, while recognizing pre-specified tapping signatures, also recognizes and filters naturally occurring motion or noise patterns not intended by a user to initiate system control transactions. Given natural variations in operator tapping parameters, and between performances of different operators, the TCVI 100 is flexible enough to reliably detect intentional operator tapping intended to initiate system control transactions from naturally occurring motion patterns (e.g., noise, vibration, striking, bumping, etc.) typical to everyday operation of the host vehicle.

The actual configuration of the TCVI 100 is as appropriate to the components, configuration, functionality, and/or form-factor of a host vehicle; the couplings shown between the TCVI 100 and components of the host vehicle therefore are representative only and are not to limit the TCVI 100 and/or the host vehicle to the configuration shown. The TCVI 100 can be implemented in any combination of software algorithm(s), firmware, and hardware running on one or more processors, where the software can be stored on any suitable computer-readable medium, such as microcode stored in a semiconductor chip, on a computer-readable disk, or downloaded from a server and stored locally at the host device for example.

Components of the TCVI 100 and host vehicle may couple in any variety of configurations under program or algorithmic control. The TCVI 100 or host vehicle may include any number, type, and/or combination of memory devices, including read-only memory (“ROM”) and random access memory (“RAM”), but is not so limited. Alternatively, the TCVI 100 can couple among various other components and/or host vehicle systems to provide automatic control of the coupled vehicle systems. These other components may include various processors, memory devices, buses, controllers, input/output devices, and displays to name a few.

While a select number of components of the TCVI 100 and the host vehicle are shown and described herein, various alternative embodiments include any number and/or type of each of these components coupled in various configurations known in the art. Further, while the sensor system 102 and signal processor 112 are shown as separate blocks, some or all of these blocks can be monolithically integrated onto a single chip, distributed among a number of chips or components of a host vehicle, and/or provided by some combination of algorithms. The term “processor” as generally used herein refers to any logic processing unit, such as one or more CPUs, digital signal processors (“DSP”), application-specific integrated circuits (“ASIC”), etc.

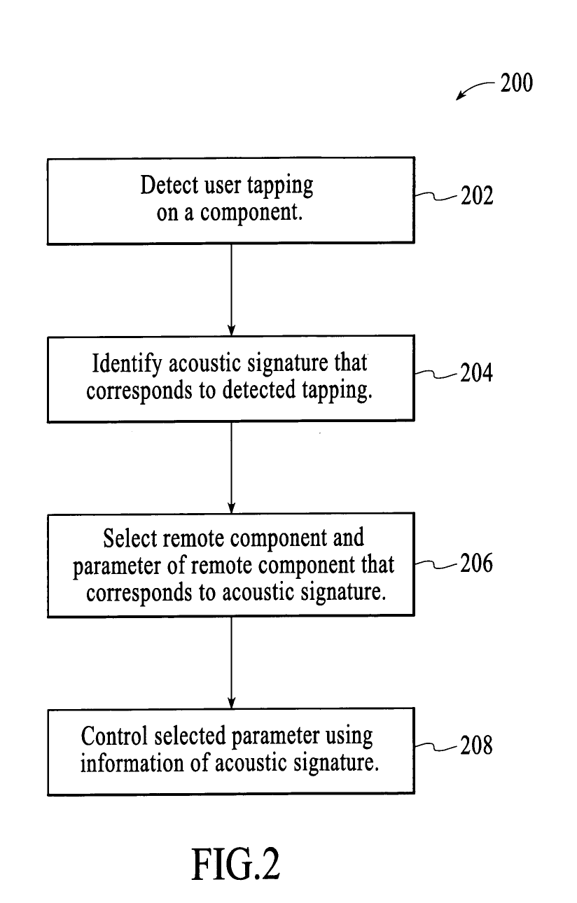

As an example of TCVI control, FIG. 2 is a flow diagram 200 for automatically controlling devices by sensing tapping of a user, under an embodiment. Sensors of the TCVI detect 202 operator tapping on a surface of at least one component of the host vehicle. Tapping detection 202 includes comparing signals of a primary sensor array and a reference sensor array. The sensor arrays of an embodiment each include at least one accelerometer-based sensor as described above. The TCVI identifies 204 a tapping signature (e.g., acoustic signature) that corresponds to the detected tapping. Using information of the identified tapping signature, the TCVI selects 206 a remote system of the host vehicle that corresponds to the tapping signature. Selection 206 of the remote system also includes selection of a parameter of the remote system that corresponds to the tapping signature. The TCVI controls 208 the selected system/parameter in accordance with the parameters of the tapping signature so that, for example, if the tapping signature corresponds to increasing the entertainment system volume the TCVI controls the increase of the volume as appropriate.

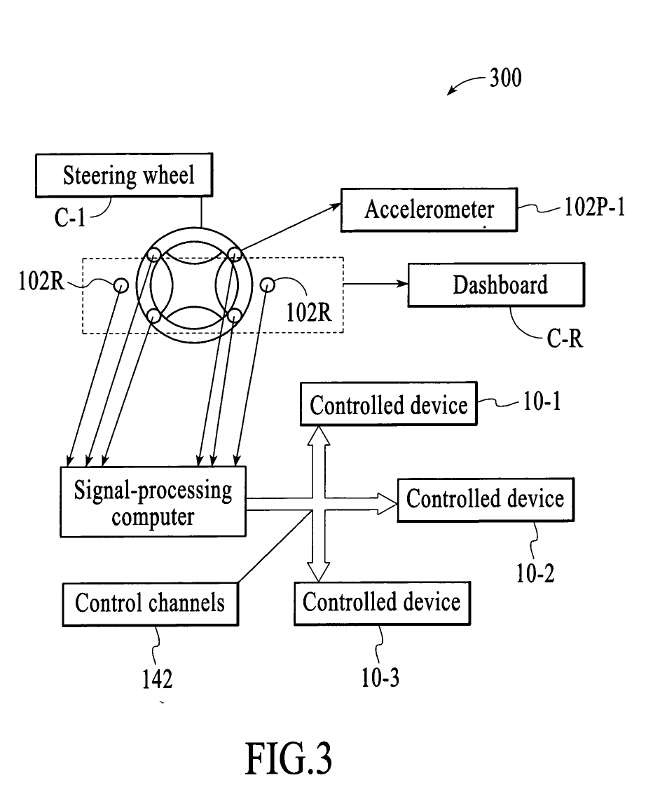

As an example of a particular application of the TCVI, FIG. 3 is a block diagram of a TCVI 300 in an automobile, under an embodiment. This example configures the steering wheel C-1 as the interactive surface of the TCVI but is not so limited. The TCVI 300 of this example includes a primary sensor array 102P-1 connected to the steering wheel C-1 of the automobile, and a reference sensor array 102R connected to the dash assembly C-R of the automobile. Sensors of the primary sensor array 102P-1 are embedded in the steering wheel while sensors of the reference sensor array 102R are connected to the dash. Together the primary sensor array 102P-1 and the reference sensor array 102R (collectively referred to as the “sensor system 102”) form the sensor system 102 as described above with reference to FIG. 1 and operating as described above with reference to FIGS. 1 and 2.

The sensor system 102 is coupled to a signal-processing computer 112. The signal-processing computer 112 is coupled to three systems 10-1, 10-2, 10-3 of the automobile via one or more control channels or signals 142, as described above. The systems might include an entertainment system 10-1, a climate control system 10-2, and a cellular telephone 10-3. While three particular systems are described in this example, the TCVI is not limited to use with these system. Tapping by the driver on the steering wheel results in generation of sensor signals by the sensor system 102. The signal-processing computer 112 receives the sensor signals and analyzes the signals in order to distinguish between signals caused by an operator tapping the steering wheel surface (received by primary sensor array 102P-1) and noise or other extraneous signals of the automobile environment (received by reference sensor array 102R).

The analysis performed by the signal-processing computer 112 uses information of the acoustic and vibration model of the TCVI. The acoustic and vibration model included as a component of the TCVI is appropriate to the configuration of the particular steering wheel (e.g., component material, size, etc.) and the automobile environment (e.g., windows up, windows down, top up, top down, road conditions, etc.). The result of the signal-processing analysis is identification of a tapping signature that corresponds to the detected tapping. The analysis uses the identified tapping signature, which includes specific parameters of location, intensity, rhythm, and repetition of the tapping, to determine which of the automobile devices 10-1/10-2/10-3 the driver wishes to control and the type of control desired. Regardless of the control mapping corresponding to the identified tapping signature, the TCVI automatically generates control signals appropriate to the mapping and initiates control of the selected device using the control signals via the appropriate control channels 142.

In one example, the identified tapping signature may include a first tapping signature that includes a series of high intensity taps each of which are separated by a short interval. The TCVI maps this first tapping signature to automatically generate control signals that increase output volume of the entertainment system 10-1 until such time as the tapping ceases. Additional tapping signatures may control other parameters of the entertainment system 10-1.

In another example, the identified tapping signature may include a second tapping signature that includes a series of high intensity taps each of which are separated by a relatively low intensity tap. The TCVI maps this second tapping signature to automatically generate control signals that increase a temperature maintained by the climate control system 10-2 by some pre-specified amount corresponding to the second tapping signature. Additional tapping signatures may control other parameters of the climate control system 10-2.

In yet another example, the identified tapping signature may include a third tapping signature that includes a pre-specified number of high intensity taps followed by a pre-specified number of relatively low intensity taps, followed by a pre-specified number of high intensity taps. The TCVI maps this third tapping signature to automatically generate control signals that activate the cellular telephone system 10-3 in a mode to receive a voice command from the driver in order to initiate a cellular telephone call. Additional tapping signatures may control other parameters of the cellular telephone system 10-3.

The TCVI of an embodiment includes a device comprising at least one of a sensor system that includes an acoustic sensor and a reference sensor, and a signal processing system (SPS) coupled to the sensor system, wherein the SPS detects tapping of a user on a surface by comparing signals of the acoustic sensor and the reference sensor, identifies an acoustic signature of the detected tapping, selects a parameter of a remote component that corresponds to the acoustic signature, and automatically initiates control of the selected parameter of the selected remote component using information of the acoustic signature.

The surface of an embodiment includes an external area of at least one of a steering device, a shift control device, and a console of a host system.

The acoustic sensor of an embodiment is an accelerometer.

The reference sensor of an embodiment is configured to sense at least one of acoustic, vibration, acceleration, and motion data corresponding to activity other than the tapping.

The acoustic sensor of an embodiment is coupled to a first surface of the host system and the reference sensor is coupled to a second surface of the host system. The first surface of an embodiment includes at least one of a steering device, a shift control device, and a console of a vehicle and the second surface includes a surface of the vehicle different from the first surface.

The SPS of an embodiment identifies the acoustic signature by identifying at least one of a location, strength, repetition, and rhythm of the tapping.

The device of an embodiment initiates control by generating a control signal for use in controlling the selected parameter of the selected remote component.

The device of an embodiment further comprises a communication system configured to transfer sensor signals from the sensor system to the SPS, wherein the communication system is at least one of a wireless communication system, a wired communication system, and a hybrid wireless and wired communication system.

The device of an embodiment further comprises a database coupled to the SPS, wherein the database includes information of the acoustic signature, the information of the acoustic signature including at least one of acoustic models and vibration models as appropriate to at least one of a material comprising the surface and an environment in which the surface is located.

The TCVI of an embodiment includes a method comprising at least one of detecting tapping by a user on at least one component, the detecting including comparing signals of an acoustic sensor and a reference sensor, identifying an acoustic signature that corresponds to the detected tapping, selecting a remote component and a parameter of the remote component that corresponds to the acoustic signature, and controlling the selected parameter using information of the acoustic signature.

The component of an embodiment includes at least one of a steering device, a shift control device, and a console of a vehicle.

The acoustic sensor of an embodiment is an accelerometer.

The reference sensor of an embodiment is configured to sense at least one of acoustic, vibration, acceleration, and motion data corresponding to activity other than the tapping.

The method of an embodiment further comprises coupling the acoustic sensor to a first component of a host system and coupling the reference sensor to a second component of the host system. The first component of an embodiment includes at least one of a steering device, a shift control device, and a console of a vehicle and the second component includes a component of the vehicle different from the first component.

The method of an embodiment further comprises identifying at least one of a location, intensity, frequency, pattern, and rhythm of the tapping.

Identifying the acoustic signature of an embodiment comprises comparing information of the detected tapping to at least one of acoustic models and vibration models.

The method of an embodiment further comprises generating a control signal for controlling the selected parameter.

The TCVI of an embodiment includes a method comprising at least one of identifying acoustic signatures that correspond to tapping detected on a component of a host vehicle, the tapping detected by comparing signals of a sensor array that includes sensors in a plurality of components of the host vehicle, identifying a device of the host vehicle that correspond to the acoustic signature, generating control signals that correspond to the device, and automatically controlling the device using the control signals.

The component of an embodiment includes at least one of a steering device, a shift control device, and a console of the host vehicle.

The sensors of an embodiment include at least one acoustic sensor and at least one reference sensor.

The method of an embodiment further comprises identifying at least one of a location, intensity, frequency, pattern, and rhythm of the tapping using at least one of acoustic models and vibration models.

The TCVI of an embodiment includes a system comprising at least one of means for identifying acoustic signatures that correspond to tapping detected on a component of a host vehicle, the tapping detected by comparing signals of a sensor means in a plurality of components of the host vehicle, means for identifying a device of the host vehicle that correspond to the acoustic signature, means for generating control signals that correspond to the device, and means for automatically controlling the device using the control signals.

The sensor means of an embodiment includes at least one acoustic sensor and at least one reference sensor.

The sensor means of an embodiment includes an acoustic sensor coupled to a first component of the host vehicle and a reference sensor coupled to a second component of the host vehicle.

The means of an embodiment for identifying acoustic signatures comprises means for comparing information of the tapping to at least one of acoustic models and vibration models.

The means of an embodiment for identifying acoustic signatures comprises means for identifying at least one of a location, intensity, frequency, pattern, and rhythm of the tapping using at least one of acoustic models and vibration models.

The component of an embodiment includes at least one of a steering device, a shift control device, and a console of the host vehicle.

The TCVI of an embodiment includes machine-readable medium that includes executable instructions, which when executed in a processing system, initiates automatic control of remote devices of a host vehicle by identifying acoustic signatures that correspond to tapping detected on a component of the host vehicle, the tapping detected by comparing signals of a sensor array that includes sensors in a plurality of components of the host vehicle, identifying a device of the host vehicle that correspond to the acoustic signature, generating control signals that correspond to the device, and/or automatically controlling the device using the control signals.

Aspects of the TCVI described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the TCVI include: microcontrollers with memory (such as electronically erasable programmable read only memory (EEPROM)), embedded microprocessors, firmware, software, etc. Furthermore, aspects of the TCVI may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various components disclosed herein may be described and expressed (or represented) as data and/or instructions embodied in various computer-readable media. Computer-readable media in which such data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the TCVI is not intended to be exhaustive or to limit the TCVI to the precise form disclosed. While specific embodiments of, and examples for, the TCVI are described herein for illustrative purposes, various equivalent modifications are possible within the scope of the TCVI, as those skilled in the relevant art will recognize. The teachings of the TCVI provided herein can be applied to other processing systems and methods, not only for the systems and methods described above.

The elements and acts of the various embodiments described above can be combined to provide further embodiments. These and other changes can be made to the TCVI in light of the above detailed description.

In general, in the following claims, the terms used should not be construed to limit the TCVI to the specific embodiments disclosed in the specification and the claims, but should be construed to include all processing systems that operate under the claims. Accordingly, the TCVI is not limited by the disclosure, but instead the scope of the TCVI is to be determined entirely by the claims.

While certain aspects of the TCVI are presented below in certain claim forms, the inventors contemplate the various aspects of the TCVI in any number of claim forms. For example, while only one aspect of the TCVI is recited as embodied in machine-readable medium, other aspects may likewise be embodied in machine-readable medium. Accordingly, the inventor reserves the right to add additional claims after filing the application to pursue such additional claim forms for other aspects of the TCVI.

What is claimed is:

1. A device comprising:
a sensor system that includes an acoustic sensor and a reference sensor; and
a signal processing system (SPS) coupled to the sensor system, wherein the SPS detects tapping of a user on a surface by comparing signals of the acoustic sensor and the reference sensor, identifies an acoustic signature of the detected tapping, selects a parameter of a remote component that corresponds to the acoustic signature, and automatically initiates control of the selected parameter of the selected remote component using information of the acoustic signature.

2. The device of claim 1, wherein the surface includes an external area of at least one of a steering device, a shift control device, and a console of a host system.

3. The device of claim 1, wherein the acoustic sensor is an accelerometer.

4. The device of claim 1, wherein the reference sensor is configured to sense at least one of acoustic, vibration, acceleration, and motion data corresponding to activity other than the tapping.

5. The device of claim 1, wherein the acoustic sensor is coupled to a first surface of the host system and the reference sensor is coupled to a second surface of the host system.

6. The device of claim 5, wherein the first surface includes at least one of a steering device, a shift control device, and a console of a vehicle and the second surface includes a surface of the vehicle different from the first surface.

7. The device of claim 1, wherein the SPS identifies the acoustic signature by identifying at least one of a location, strength, repetition, and rhythm of the tapping.

8. The device of claim 1, wherein the device initiates control by generating a control signal for use in controlling the selected parameter of the selected remote component.

9. The device of claim 1, further comprising a communication system configured to transfer sensor signals from the sensor system to the SPS, wherein the communication system is at least one of a wireless communication system, a wired communication system, and a hybrid wireless and wired communication system.

10. The device of claim 1, further comprising a database coupled to the SPS, wherein the database includes information of the acoustic signature, the information of the acoustic signature including at least one of acoustic models and vibration models as appropriate to at least one of a material comprising the surface and an environment in which the surface is located.

11. A method comprising:
detecting tapping by a user on at least one component, the detecting including comparing signals of an acoustic sensor and a reference sensor;
identifying an acoustic signature that corresponds to the detected tapping;
selecting a remote component and a parameter of the remote component that corresponds to the acoustic signature; and
controlling the selected parameter using information of the acoustic signature.

12. The method of claim 11, wherein the component includes at least one of a steering device, a shift control device, and a console of a vehicle.

13. The method of claim 11, wherein the acoustic sensor is an accelerometer.

14. The method of claim 11, wherein the reference sensor is configured to sense at least one of acoustic, vibration, acceleration, and motion data corresponding to activity other than the tapping.

15. The method of claim 11, further comprising coupling the acoustic sensor to a first component of a host system and coupling the reference sensor to a second component of the host system.

16. The method of claim 15, wherein the first component includes at least one of a steering device, a shift control device, and a console of a vehicle and the second component includes a component of the vehicle different from the first component.

17. The method of claim 11, further comprising identifying at least one of a location, intensity, frequency, pattern, and rhythm of the tapping.

18. The method of claim 11, wherein identifying the acoustic signature comprises comparing information of the detected tapping to at least one of acoustic models and vibration models.

19. The method of claim 11, further comprising generating a control signal for controlling the selected parameter.

20. A method comprising:
identifying acoustic signatures that correspond to tapping detected on a component of a host vehicle, the tapping detected by comparing signals of a sensor array that includes sensors in a plurality of components of the host vehicle;
identifying a device of the host vehicle that correspond to the acoustic signature;
generating control signals that correspond to the device; and
automatically controlling the device using the control signals.

21. The method of claim 20, wherein the component includes at least one of a steering device, a shift control device, and a console of the host vehicle.

22. The method of claim 20, wherein the sensors include at least one acoustic sensor and at least one reference sensor.

23. The method of claim 20, further comprising identifying at least one of a location, intensity, frequency, pattern, and rhythm of the tapping using at least one of acoustic models and vibration models.

24. A system comprising:
means for identifying acoustic signatures that correspond to tapping detected on a component of a host vehicle, the tapping detected by comparing signals of a sensor means in a plurality of components of the host vehicle;
means for identifying a device of the host vehicle that correspond to the acoustic signature;
means for generating control signals that correspond to the device; and
means for automatically controlling the device using the control signals.

25. The system of claim 24, wherein the sensor means includes at least one acoustic sensor and at least one reference sensor.

26. The system of claim 24, wherein the sensor means includes an acoustic sensor coupled to a first component of the host vehicle and a reference sensor coupled to a second component of the host vehicle.

27. The system of claim 24, wherein the means for identifying acoustic signatures comprises means for comparing information of the tapping to at least one of acoustic models and vibration models.

28. The system of claim 24, wherein the means for identifying acoustic signatures comprises means for identifying at least one of a location, intensity, frequency, pattern, and rhythm of the tapping using at least one of acoustic models and vibration models.

29. The system of claim 24, wherein the component includes at least one of a steering device, a shift control device, and a console of the host vehicle.

30. A machine-readable medium that includes executable instructions, which when executed in a processing system, initiates automatic control of remote devices of a host vehicle by:
identifying acoustic signatures that correspond to tapping detected on a component of the host vehicle, the tapping detected by comparing signals of a sensor array that includes sensors in a plurality of components of the host vehicle;
identifying a device of the host vehicle that correspond to the acoustic signature;
generating control signals that correspond to the device; and
automatically controlling the device using the control signals.
